(19) United States
(12) Patent Application Publication
(10) Pub. No.: US 2007/0212483 A1
(43) Pub. Date: Sep. 13, 2007

(54) Slurry applying device and device for inspecting defects of slurry application

(75) Inventors: Koichi Miyashita, Kasugai-city (JP); Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/708,592

(22) Filed: Feb. 21, 2007

(30) Foreign Application Priority Data
Mar. 8, 2006 (JP) 2006-062399
Jan. 9, 2007 (JP) 2007-000904

(51) Int. Cl. B05D 7/22; B05C 13/02

(52) U.S. Cl. 427/232; 118/52

(57) ABSTRACT

Problem to be solved is to provide a means to make the thickness of a ceramic slurry in a container uniformly in a process to form plugged portions in a honeycomb structure. The solution is provided with a slurry applying device 1 comprising a plate shaped container 2 which a base 21 is flat, a fixed quantity non-pulsatile pump 3 to which a slurry 31 is discharged to the base 21 of the container 2, a discharge opening moving means which relatively moves a position of a discharge opening of the pump 3 between center 22 and periphery 23 of the base 21 of the container 2, and a container rotating means for application which rotates the container 2 as a rotating axis with the center 22 of the base 21.

### TECHNICAL FIELD

The present invention relates to a device which can apply a slurry at the determined thickness without producing air bubble to a container which a base is flat, and a device for inspecting the presence or absence of defects of application such as air bubble, non-applying, or the like in slurry applied.

### BACKGROUND

There is a large amount of particulate matter (fine particle matter, PM) consisting of a soot (carbon black smoke) and the like in exhaust gas emitted from diesel engines or the like. Since the emission of this PM in the atmosphere causes environmental pollution, a filter to trap the PM is mounted on an exhaust system of diesel engines. Furthermore, a plugged honeycomb structure is employed as this filter in many cases (for example, refer to Patent Literature 1).

A plugged honeycomb structure includes the honeycomb structure having a plurality of cells which penetrates through in an axial direction divided by porous partition walls, in which one end portion of partial cells in one end surface thereof is plugged and one end portion of remaining cells in the other end surface thereof. Exhaust gas (treating gas) flows into the cells which are not plugged in an end surface of an inlet side of this plugged honeycomb structure and are plugged in an end surface of an outlet side of the plugged honeycomb structure, and passes through the porous partition walls. Then, it moves the cells which are plugged in the end surface of the inlet side of the plugged honeycomb structure and are not plugged in the end surface of the outlet side of the plugged honeycomb structure, and is emitted. Alternatively, in this time, the partition walls become a filter layer and thereby PM in exhaust gas is trapped.

[Patent Literature 1] JP-A-2001-269585

This plugged honeycomb structure has conventionally had problems relating to plugged portions (portions plugged cells) as below. One of the problems is an increase of pressure loss as a filter by existence of the plugged portions. Especially, when the plugged portions are thick in the length direction of the cell, the filtering area as the filter is decreased in just it. Thus, when the same amount of treating gas is passed through the cells, the pressure loss as the filter is raised to just it.

Other problems relating to the plugged portions are occurrences of unintended small holes and cracks at the plugged portions or a decrease of a process yield caused by existence of further small air bubble passed through in a manufacturing process. This honeycomb structure can not be shipped because exhaust gas can not be passed through porous partition walls to leak and a decrease of the filtering performance as a filter is invited. Therefore, honeycomb structures which the leak is observed are removed from the products after conducting a leaking examination with filling with a smoke before a shipment.

The problem of this decrease of process associates with the above first problem. That is, in a formed honeycomb body before firing (not yet a fired honeycomb structure), as a result of the difference of the shrinkage rate during firing between plugged portions (portions filled with a plugging material during manufacture) in two of the end surfaces of the plugged honeycomb structure and unplugged portions, it is considered that cracks may be occurred in the formed honeycomb body. When the plugged portions is thick in length direction of the cells, the difference of the shrinkage rate between portions filled with a plugging material (plugged portions) and portions without filling with the plugging material (unplugged portions) in the formed honeycomb body is large in just it. Therefore, the cracks are easily occurred.

### SUMMARY OF THE INVENTION

The present invention has been made in view of the above-mentioned conventional circumstances. The present invention finally aims to provide a means for manufacturing a plugged honeycomb structure having low pressure loss, with the increase of the process yield. As a result of a study, the applicant has found that it is important to control the thickness of a ceramic slurry used as a plugging material and inspect a rest of air bubble in a process of forming plugged portions in a honeycomb structure, in order to solve the above-mentioned problems, since a process for forming the plugged portions in the honeycomb structure can be realized by the following matter; for example, an end surface of a honeycomb structure conducted a mask in unplugged cells is immersed in a ceramic slurry contained in a container, filled only cells to be plugged with the ceramic slurry, and then the end surface is dried and fired. Consequently, the present invention directly aims to provide a means for inspecting so that air bubble is unmixed in the ceramic slurry as well as to control the thickness of the ceramic slurry in a container uniformly in a process to form plugged portions in a honeycomb structure. As a result of further studies, the aim was achieved by a means shown in the following, there was further found to solve the final problem.

That is, at first, according to the present invention, a slurry applying device comprising a plate shaped container which a base is flat, a slurry discharge means to discharge a slurry to the base of the container, a container rotating means for application to rotate the container, and the displacement meter which measures the thickness of slurry discharged by the slurry discharge means, is provided.

For example, as the slurry discharge means, a fixed quantity non-pulsatile pump which can discharge by fixed quantity without pulsating is employed.

In a slurry applying device of the present invention, it is preferable to further comprise a displacement meter moving means to move a displacement meter.

In a slurry applying device of the present invention, it is preferable to further comprise a control means A, regulating more than any one of the discharge volume of a slurry of a slurry discharge means and the rotating rate of a container rotating means for application based on data of the thickness of the slurry measured by the displacement meter, together with inputting the thickness.

In a slurry applying device of the present invention, it is preferable to further comprise a discharge opening moving means which relatively moves a position of a discharge opening of the slurry discharge means between center and periphery of the base of the container.

The center of the base means center of a plane figure constituting a base. The discharge opening moving means is a means to move relatively, and a discharge position of the discharge opening of means may be moved from center to periphery of the base of the container by moving a container, but it is preferable that a discharge opening moving means is a means to move a slurry discharge means in a slurry applying device of the present invention.

In a slurry applying device of the present invention, when a discharge opening moving means is comprised, it is preferable to further comprise a control means B, regulating the moving rate of the discharge opening moving means based on data of the thickness of the slurry measured by a displacement meter, together with inputting the thickness.

When the control means A comprises a discharge opening moving means, the control means A may be combined with this control means B. When merely control means is said in the present specification, both the control means A and the control means B are pointed.

In a slurry applying device of the present invention, it is preferable for a displacement meter to be a laser displacement meter. The reason is because a resolution and an object of wide materials can be measured. If a displacement meter is a material of non-contact type, it can be employed. The displacement meter such as Foucault currents type, a supersonic wave type, LED type, or the like can be employed, as another materials.

Next, according to the present invention, a method for applying a slurry to a base of a plate shaped container which the base is flat, in which the method comprises measuring the thickness of the slurry discharged together with discharging the slurry to the base of the container while rotating the container by using a slurry discharge means, and regulating more than any one of the discharging volume of the slurry and the rotating rate of the container based on the thickness of the slurry measured, is provided.

In a method for applying a slurry of the present invention, it is preferable to regulate the moving rate of a discharge opening based on the thickness of slurry measured together with relatively moving a position of the discharge opening of a slurry discharge means between center and periphery of a base of a container.

Next, according to the present invention, a method for manufacturing a plugged honeycomb structure (it is called first manufacturing method of the present invention) comprising a process which includes manufacturing a formed honeycomb body having a plurality of cells which penetrates in axial direction divided by porous partition walls, conducting a mask only cells which are not plugged in the plurality of cells and are opened in an end surface of the formed honeycomb structure with pasting a film, applying a slurry to a base of a plate shaped container which the base is flat by means of the method for applying a slurry according to any of the above-mentioned methods using the slurry consisting of a ceramic material, and firing the formed honeycomb body after an end surface of the formed honeycomb body masked only the cells without plugging is immersed in a slurry applied to the container to plug by a slurry consisting of a ceramic material, is provided.

Next, according to the present invention, a device for inspecting defects of a slurry application comprising a plate shaped container which a base is flat and a slurry is applied to the base, a camera which images the slurry applied to the base, located above the base of the container, and an upward lighting which lights the slurry applied to the base from upward, located similarly above the base of the container, is provided.

In a device for inspecting defects of a slurry applying of the present invention, it is preferable to further comprise a camera position moving means which relatively moves a position of the camera between center and periphery of the base of the container.

A camera position moving means can relatively move a position of a camera between center and periphery of a base of a container by moving the camera or the container, but it is preferable to move the camera.

In a device for inspecting defects of a slurry application of the present invention, it is preferable to further comprise an upward lighting position moving means which relatively moves a position of the upward lighting between center and periphery of a base of a container.

An upward lighting position moving means can relatively move a position of an upward lighting between center and periphery of a base of a container by moving a camera or the container, but it is preferable to move the upward lighting. Alternatively, there may use a laser line sensor as a substitute for the camera and the lightning.

In a device for inspecting defects of a slurry application of the present invention, it is preferable to further comprise a lateral lighting which lights slurry applied to a base from lateral, located in a lateral of a base of a container.

In a device for inspecting defects of a slurry application of the present invention, it is preferable to further comprise a lateral lighting position moving means which relatively moves a position of the lateral lighting along periphery (a lateral side) of a container.

A lateral lighting position moving means can relatively move a position of a lateral lighting along periphery (a lateral side) of a container by moving the lateral lighting or the container, but it is preferable to move the lateral lighting.

In a device for inspecting defects of a slurry application of the present invention, it is preferable to further comprise a container rotating means for inspection to rotate a container as a rotating axis with center of a base. Alternatively, it is preferable to install a vibration device which adds a vibration to a container. This is because slurry discharged in the container is easy to equalize in the container by vibrating the container.

On the occasion of use of a device for inspecting defects of a slurry application of the present invention, when a camera is moved or not moved, or when a lateral lighting is moved or not moved, it is preferable to rotate a container by means of a container rotating means for inspection in each these case.

Next, according to the present invention, a method for inspecting defects of slurry applied to a base of a plate shaped container which the base is flat, in which the method is a method for inspecting defects of a slurry application and comprises lighting a slurry applied to the base of the container from upward and lateral of the base of the container, and inspecting defects of the application by means of taken images by a camera from upward of the base of the container, is provided.

Next, according to the present invention, a method for manufacturing a plugged honeycomb structure (it is called second manufacturing method of the present invention) comprising a process which includes manufacturing a formed honeycomb body having a plurality of cells which penetrate in axial direction divided by porous partition walls, conducting a mask only cells which are not plugged in the plurality of cells and are opened in an end surface of the formed honeycomb structure with pasting a film, applying a slurry to a base of a plate shaped container which the base is flat by using the slurry consisting of a ceramic material, inspecting defects of the application of slurry applied to the base of the container by means of the above-mentioned method for inspecting defects of a slurry application, and firing the formed honeycomb body after an end surface of the formed honeycomb body masked only the cells without plugging is immersed in slurry applied to the container to plug by a slurry consisting of a ceramic material when the defects are not detected in the slurry applied to the container, is provided. In addition, both the first production method and the second production method of the present invention are pointed when a method for manufacturing a plugged honeycomb structure of the present invention is merely said hereinafter.

In addition, in the present specification, a container is expressed a plate shaped, but a base (of a container) is flat and a peripheral part (of a container) is stood since a seal is needed at a part of the peripheral wall (surface) of a formed honeycomb body. Therefore, it may be said that it is a shape like a tray considering this embodiment. A plane shape of a container (a shape of a plane figure constituted a base) can be decided to a work and exemplified as a circle, an oval, or the like.

Since a slurry applying device of the present invention comprises a slurry discharge means, a container rotating means for application and a displacement meter, in which the slurry can be discharged to center of a base of a container, the container can be rotated as a rotating axis with the center of the base of the container, the slurry can be spread in layer by a centrifugal force, and the thickness of the slurry spread in layers can be measured by the displacement meter to inspect and confirm. By a method for applying a slurry of the present invention, a similar effect is provided. In addition, it may make scan the thickness of a slurry by comprising a plurality of displacement meters or moving one displacement meter. Since a slurry applying device of the present invention further comprises a displacement meter moving means in a preferable embodiment, the thickness of a slurry at every position of the slurry spread in layer can be measured by one displacement meter.

A slurry applying device of the present invention further comprises a control means A in a preferable embodiment, it can be applied a slurry while regulating more than any one of the discharge volume of a pump (a slurry discharge means) and the rotating rate of a container rotating means for application based on the thickness of slurry measured by means of a displacement meter. For example, a container can be rotated to the viscosity of a slurry at a rate so that optimal centrifugal force to make the slurry flat is produced. Therefore, the above-mentioned effect that a slurry applying device of the present invention can apply a slurry so as to be a uniform thickness and a flat layer without an undulation, can be more entirely exhibit at higher level.

Since a slurry applying device of the present invention further comprise a discharge opening moving means in a preferable embodiment, it can discharge a slurry to a base of a container as following; a fixed quantity non-pulsatile pump is used as a slurry discharge means, for example and the position of a discharge opening of the pump is relatively moved from center to periphery of a base of a container, while rotating a container as a rotating axis with the center of the base, for example. In addition, when a control means B is comprised, a slurry can be discharged while regulating the moving rate of a discharge opening moving means. Therefore, the above-mentioned effect that a slurry applying device of the present invention can apply slurry so as to be a uniform thickness and a flat layer without an undulation, can be more entirely exhibit at higher level.

A device for inspecting defects of a slurry application of the present invention comprises a camera which images the slurry, located above the base of the container to which the slurry is applied, a upward lighting which lights the slurry from upward thereof. Therefore, color difference caused by the upward lighting between the slurry (as a material) and a container (as a material) can be easily detected, and the existence of non-slurry-applying parts can be entirely detected. Also, by a method for inspecting defects of a slurry applying of the present invention, a similar effect is provided.

A device for inspecting defects of a slurry application of the present invention has a lateral lighting which lights the slurry from lateral, located in lateral of a container to which the slurry is applied. Thus, a shadow of air bubble in the slurry (materials) can be easily detected by means of an image processing, and the air bubble existing in the slurry can be entirely detected.

Since a method for manufacturing a plugged honeycomb structure of the present invention uses a method for applying a slurry and/or a method for inspecting defects of a slurry application of the present invention to plug cells of a honeycomb structure by a slurry consisting of a ceramic material, it is possible that plugged portions becomes more thinner with uniform thickness to the length direction of the cells. Therefore, a plugged honeycomb structure obtained a method for manufacturing a plugged honeycomb structure may have a smaller pressure loss.

A method for manufacturing a plugged honeycomb structure of the present invention (the second method for manufacturing of the present invention) can manufacture a plugged honeycomb structure so that air bubble is not mixed in plugged portions thereof. Thus, a process yield can be increased and productivity is improved. Alternatively, since a slurry having defects is not needed to use by means of a method for inspecting defects of a slurry application of the present invention, a honeycomb structure is not disposed with waste. From this viewpoint, it may be said that a method for manufacturing a plugged honeycomb structure of the present invention is a means to contribute to the process yield and the improvement of productivity.

### BRIEF DESCRIPTION OF THE DRAWINGS

FIG. 1 is a perspective view showing one embodiment of a slurry applying device of the present invention.

FIG. 2 is a sectional view showing one embodiment of a slurry applying device of the present invention.

FIG. 3 is a top view showing one embodiment of a device for inspecting defects of a slurry application of the present invention.

FIG. 4 is a sectional view showing one embodiment of a device for inspecting defects of a slurry application of the present invention.

FIG. 5 is a figure showing one embodiment of a method for producing a plugged honeycomb structure of the present invention, and is a perspective view showing one example of a formed honeycomb body.

FIG. 6 is a figure showing one embodiment of a method for producing a plugged honeycomb structure of the present invention, and is a plane view showing an end surface of a formed honeycomb body.

FIG. 7 is a figure showing one embodiment of a method for producing a plugged honeycomb structure of the present invention, and is a sectional view which shows a state that an end surface of a formed honeycomb body is immersed into a slurry which is applied to a container.

FIG. 8 is a figure showing one embodiment of a method for producing a plugged honeycomb structure, and is a perspective view showing one example of a plugged honeycomb structure.

FIG. 9 is a figure showing one embodiment of a method for producing a plugged honeycomb structure, and is a sectional view which shows AA section in FIG. 8.

FIG. 10 is a sectional view of a device for inspecting defects of a slurry application of the present invention, (a) is a figure showing a state in case air bubble near a lateral lighting is not lighted up by the lateral lighting, and (b) is a figure showing a state in case air bubble moved in the distance from a lateral lighting is lighted up by the lateral lighting.

FIG. 11 is a sectional view of a slurry applying device to explain one embodiment of a method for applying a slurry of the present invention, (a) is a figure showing a state just after discharging a slurry, and (b) is a figure showing a state which a slurry comes to be flat.

FIG. 12 is a sectional view showing the other embodiment of a device for inspecting defects of a slurry application of the present invention.

### DENOTATION OF REFERENCE NUMERALS

1; slurry applying device, 2; container, 3; pump, 4; stage, 5, 5a, 5b; displacement meter, 6; camera, 7; upward lighting, 8; lateral lighting, 10; device for inspecting defects of a slurry application, 21; base (of a container), 22; center (of a base of a container), 23; periphery (of a container), 24; non-applying portion, 25, 25a; air bubble, 31; slurry, 51 formed honeycomb body, 52; partition walls, 53; cells, 54; outer wall, 60; laser line sensor and 81; plugged honeycomb structure.

### DETAILED DESCRIPTION OF THE INVENTION

Embodiments of the present invention are hereinbelow described in detail with referring to drawings arbitrarily. However, the present invention is construed limitedly to these embodiments, and various kinds of change, modification, improvement and substitution may be given based on knowledge of those skilled in the art as long as it does not deviating from the present invention. For example, drawings show preferable embodiments of the present invention, but the present invention is not limited by embodiments or information shown in the drawings. When the present invention is carried out or inspected, means similar or equal to one described in the present specification may be applied, but preferable means are described hereinafter.

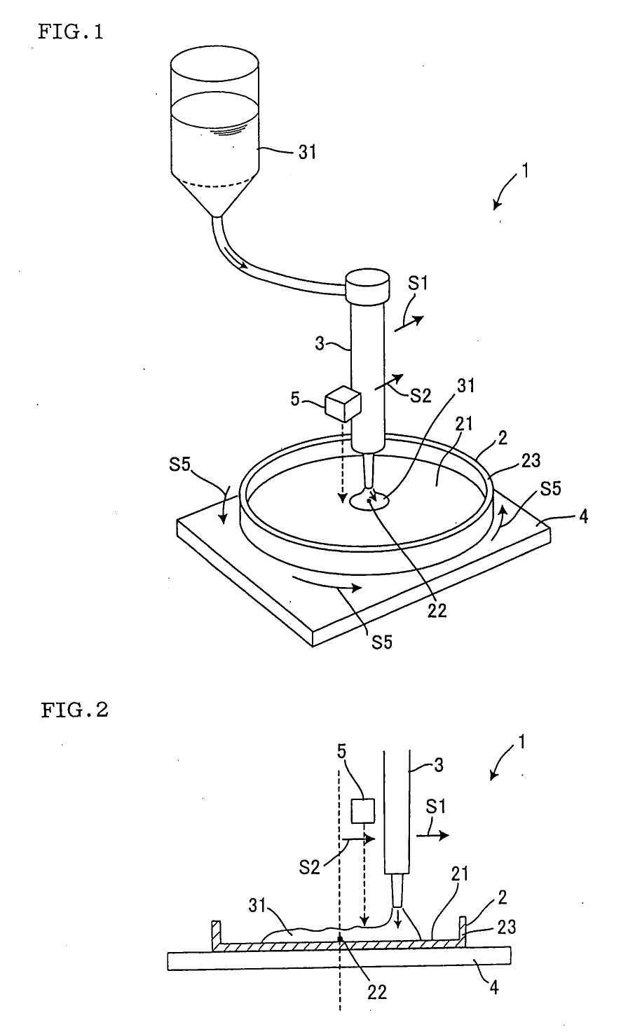

Firstly, a slurry applying device of the present invention is explained. The slurry applying device of the present invention is the device which can apply a slurry to a container having a flat base without producing air bubble with the predetermined thickness. FIGS. 1 and 2 are figures which show one embodiment of the slurry applying device of the present invention, FIG. 1 is a perspective view, and FIG. 2 is a sectional view, respectively.

The slurry applying device 1 shown in FIGS. 1 and 2 comprising a plate shaped container 2 which a base 21 is flat, a fixed quantity non-pulsatile pump 3 which is a slurry discharge means to discharge a slurry 31 to the base 21 of the container 2, a displacement meter moving means (not shown) and a container rotating means for application.

When a ceramic material is employed as the slurry 31, it is preferable for the container 2 to be material made up of a metallic material such as aluminum, or the like. The reason is because distinction with the slurry 31 becomes clear by means of irradiate with a lighting.

It is preferable to use a mohno pump as the pump 3 which is the slurry discharging means. The mohno pump is one axis eccentricity screw pump of a rotary capacity type and which has a rotor and a stator and forms a continuous spiral space sealed between these, wherein the slurry can be discharged at a fixed-quantity without a pulsation by carrying out a reciprocating motion while rotating the rotor in the stator. This is a preferable pump for the slurry applying device 1 in that a newly slurry can be discharged while an applying condition of already discharged slurry is well kept.

Specifications of the mohno pump are decided depending on a property of slurry to be treated. When a ceramic material is used as the slurry 31 to carry out plugging of a honeycomb structure, the viscosity of the slurry 31 is around 50-1000 (poise) and the specific gravity of the slurry 31 is around 1.5-2.0 g/cm³. In this case, as for the mohno pump, it is preferable to use one of having the discharging rate at 0.5-60 cc/sec.

The container rotating means for application is a means which the container 2 is rotated in a direction of, for example, arrow S5 in FIG. 1 as a rotating axis with center 22 of the base 21. A rotary motor (not shown) is installed to a stage 4 fixed the container 2, and the stage 4 is rotated, whereby the container rotating means for an application can be realized. The rotary motor may be directly installed in the container 2. In case of using a ceramic material as the slurry 31, it is preferable that the container is rotated at around 0.1-300 rpm in order to plug a honeycomb structure. Alternatively, not shown in figures, it is preferable to install a vibration device which adds a vibration to the container 2. This is because slurry discharged in the container 2 is easy to equalize in the container 2 by vibrating the container 2.

The discharge opening moving means is a means in which a discharge opening position of the pump 3 is moved from center 22 to periphery 23 of the base 21 of the container 2, to a direction of arrow S1 in FIGS. 1 and 2, for example. The pump 3 is installed in a XY motion (two directions motion) guide instrument combined a LM guide (a linear-motion guide instrument) (not shown), for example, whereby the discharge opening moving means can be realized. There may be constituted that the pump 3 is fixed, the XY motion (two directions motion) guide instrument is disposed in the stage 4 as well as a rotary motor, and therefore a linear-motion is performed while rotating the stage 4 and a position of a discharge opening of the pump 3 is moved from center 22 to periphery 23 of the base 21 of the container 2. The discharge opening moving means is not limited, but it is preferable that a position of a discharge opening of the pump 3 is moved at a rate of around 1-50 mm/sec. in order to plug a honeycomb structure, in case of using a ceramic material as the slurry 31.

The slurry applying device 1 comprises a displacement meter 5 measuring the thickness of slurry 31 discharged from the pump 3 to the base 21 of the container 2. For example, as this displacement meter 5, a laser displacement meter can be employed. Concrete specifications of the displacement meter 5, in which a light source is a red semiconductor laser (wavelength 650 nm, output 4.8 mW), the resolution is 0.2 μM and the measuring range is 80±15 mm, can be illustrated.

In the slurry applying device 1, the displacement meter 5 moves by means of a displacement meter moving means (not shown) toward a direction arrow S2 in FIGS. 1 and 2, for example, to a position of a discharging opening of the pump 3 which moves from center to periphery of the base of the container by the discharge opening moving means. The displacement meter 5 is installed in the XY motion (two directions motion) guide instrument combined the LM guide (a linear-motion guide instrument) (not shown), for example, whereby the displacement meter moving means can be realized.

The slurry applying device 1 (not shown) possesses a control means, in which more than any one of the discharge volume of the slurry 31 of the pump 3, the rotating rate of the container rotating means for application (the rotating rate of a stage 4) and the moving rate of the discharge opening moving means based on data of the thickness of the slurry 31 can be regulated. This control means can be comprised of a sequencer having an input and output functions or a computer for the industry.

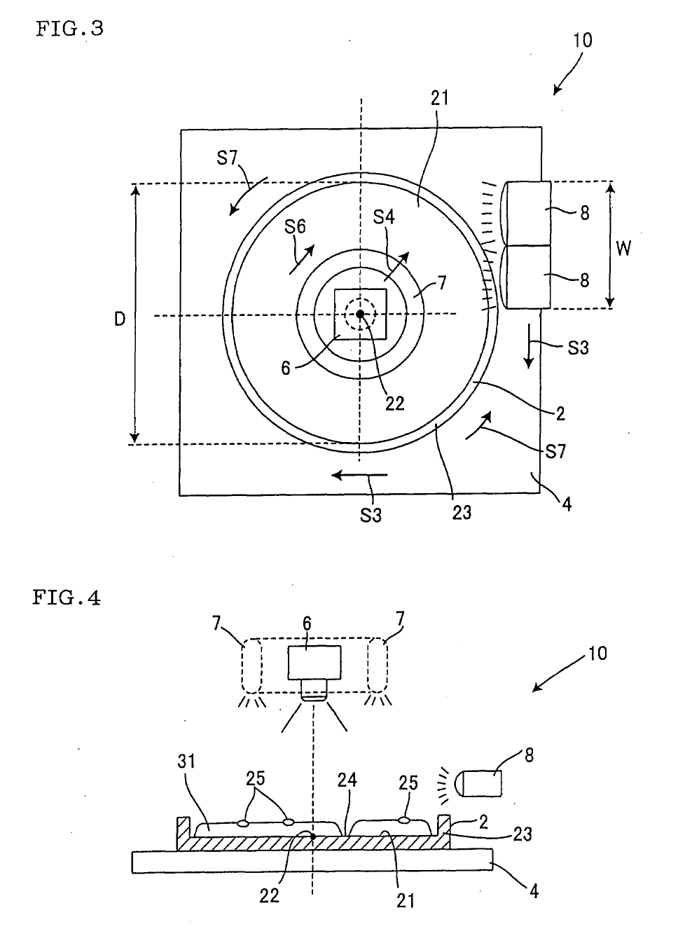

Next, a device for inspecting defects of a slurry application of the present invention is explained. The device for inspecting defects of the slurry application of the present invention is a device which can precisely inspect defects of an application such as air bubble, non-applying, or the like in slurry applied. FIGS. 3 and 4 are figures which show one embodiment of the device for inspecting defects of the slurry application of the present invention. FIG. 3 is a top view (a plane view) and FIG. 4 is a sectional view, respectively.

The device for inspecting defects of the slurry application 10 shown in FIGS. 3 and 4 comprising a plate shaped container 2 which a base 21 is flat and a slurry 31 is applied to the base 21, a camera 6 which images the slurry 31 applied to the base 21, located above the base 21 of the container 2, a ring type upward lightings 7, for example, disposed so as to be across the camera 6 which light the slurry 31 applied to the base 21 from upward, located similarly above the base 21 of the container 2 and two lateral lightings 8, for example, which light the slurry 31 applied to the base 21 from lateral, located lateral of the base 21 of the container 2. The camera 6 is employed one which has 2000000 pixels or more of the resolution in a color CCD system, for example, since around φ 1 mm of air bubble 25 or around 1 mm of non-applying part 24 is detected. In addition, the slurry 31 is omitted in FIG. 3, and is not drawn. Alternatively, the most parts of the air bubble 25 are existed on the surface of the slurry 31, and they swell out spherically.

The device for inspecting defects of the slurry application 10 comprises a container rotating means for inspection which rotates the container toward a direction of arrow S7 in FIG. 3, for example, as a rotating axis with center 22 of the base 21 of the container 2. Alternatively, the device for inspecting defects of the slurry application comprises a camera position moving means in which a position of the camera 6 is moved from center 22 to periphery 23 of the base 21 of the container 2, toward a direction of arrow S4 in FIG. 3, for example. Further, the device for inspecting defects of slurry application comprises an upward lighting position moving means in which a position of the upward lighting 7 is moved from center 22 to periphery 23 of the base 21 of the container 2, toward a direction of arrow S6 in FIG. 3, for example. Additionally, the device for inspecting defects of the slurry application comprises a lateral lighting position moving means in which a position of the lateral lighting 8 is moved along periphery 23 of the container 2, toward a direction of arrow S3 in FIG. 3, for example. The lateral lighting position moving means may move roundly to a circular container 2.

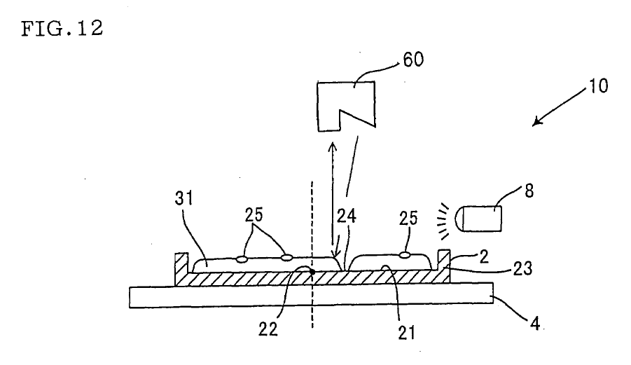

In addition, the device for inspecting defects of the slurry application 10 comprises all means, but the container rotating means for inspection, the camera position moving means, the upward lighting position moving means and the lateral lighting position moving means are not essential structural elements in the device for inspecting defects of the slurry application of the present invention, and these means can be selectively comprised. For example, the device for inspecting defects of the slurry application of the present invention additionally comprised only the container rotating means for inspection is used to fix the camera, the upward lighting and the lateral lighting in the device, and only THE container is rotated, whereby the defects of the slurry application can be inspected. Alternatively, there may use a laser line sensor as a substitute for the camera and the lightning. The laser line sensor may be used a commercially available one such as KEYENCE LJ-G030, 080 200, or the like. Specifically, as shown in FIG. 12, the laser line sensor 60 is disposed at upward of the base of the container and defections of the slurry application can be detected by a laser irradiation of the slurry 31 applied to the base 21. In addition, the laser line sensor 60 is moved together with a pump 3.

The container rotating means for inspection can be realized by installing a rotary motor to the stage 4 fixed the container 2 and rotating a stage 4. The rotary motor may be directly installed to the container 2. It is preferable that the container 2 is rotated at around 0.1-300 rpm in order to plug a honeycomb structure in case of using a ceramic material as the slurry 31.

The camera position moving means, the upward lighting position moving means and the lateral lighting position moving means can be realized by installing, for example, the camera 6, the upward lighting 7 and the lateral lighting 8 to a XY motion (two directions motion) guide instrument combined with a LM guide (linear-motion guide instrument), respectively. A position of the camera 6 and the upward lighting 7 can be also realized by the following relatively movement; the stage 4 on which the container 2 is put is installed to the XY motion (two directions motion) guide instrument and moved. However, because it is desirable that the positioning relation between the camera 6 and the upward lighting 7, and the lateral lighting 8 is adjusted, a means which moves the camera 6, the upward lighting 7 and the lateral lighting 8 separately is employed.

The upward lighting 7 and the lateral lighting 8 depend on the properties of using slurry, color, or the like, but is employed one having maximum illuminance of 260000-600000 lux and color temperature of 3000-3100 K. Alternatively, it is preferable that width W of two lateral lightings 8 is ½ or more of diameter D of a circular container 2. The reason is because at least ¼ or more of the container are lighted up. For example, in case of using inspection of plugging of a honeycomb structure, the inside diameter D of the container 2 is around 110-410 mm since the diameter of the honeycomb structure is almost 100-400 mm in many cases. Therefore, it is preferable that the width W of the lateral lighting 8 is 50-200 mm or more.

Next, a method for manufacturing a plugged honeycomb structure of the present invention is firstly explained as an example, in case of using the above-mentioned slurry applying device 1 and device for inspecting defects of the slurry application 10. Secondly, methods for applying a slurry and inspecting defects of a slurry application of the present invention are explained through the above method. In addition, as to processes other than the plugging process, refer to Patent Literature 1 in conjunction with the following explanation.

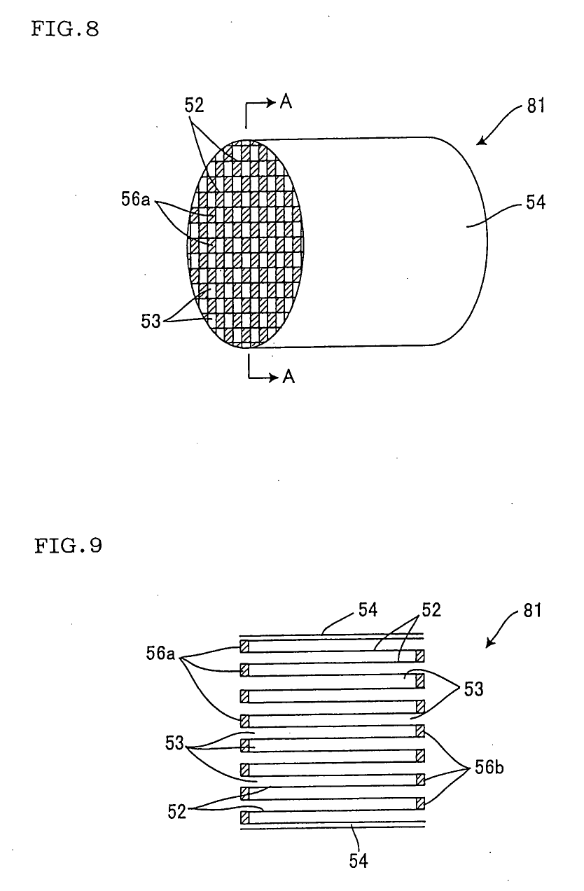

FIGS. 8 and 9 are figures which show one example for the plugged honeycomb structure as an object of production. FIG. 8 is a perspective view thereof and FIG. 9 is a sectional view which shows AA section in FIG. 8, respectively. The plugged honeycomb structure 81 is a honeycomb structure having a plurality of cells 53 which penetrate through in an axial direction divided by porous partition walls 52, inside of an external wall 54 formed almost a tubular shape, in which plugged portions 56a are formed at one end portion of partly cells 53 in one end surface thereof to plug the cells 53 and plugged portions 56b are formed at the other end portions of the remaining cells 53 in the other end surface.

In order to this plugged honeycomb structure 81, a formed honeycomb body (a unfired body) having the same shape as the plugged honeycomb structure 81 except without forming plugged portions is firstly prepared and then dried. Then, both end surfaces of the formed honeycomb body are processed by a cutting so as to have predetermined length thereof.

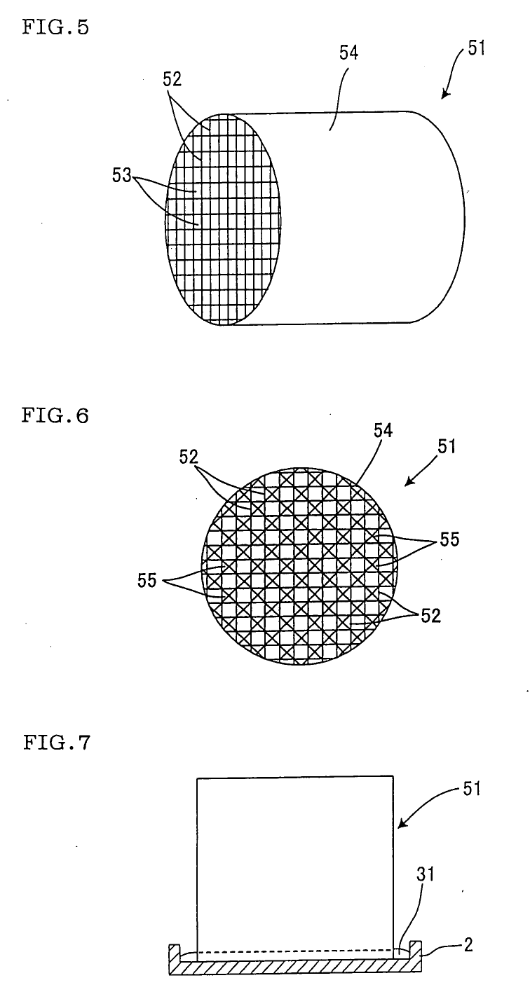

FIG. 5 is a perspective view which shows one example of the formed honeycomb body after both end surfaces was cut and aligned. The formed honeycomb body 51 as shown in FIG. 5 has a plurality of cells 53 which penetrate through in an axial direction divided by the partition walls 52, inside of the external wall 54 formed almost tubular shape. In order to obtain the formed honeycomb body 51, a porous material is used as a forming material and the porous material is kneaded with water, a binder and additives to obtain a clay. Then, the obtained clay may be formed into a honeycomb shape.

A ceramic material such as a cordierite forming material, almina, mullite, lithium aluminum silicate, aluminum titanate, titania, zirconia, silicon nitride, aluminum nitride, silicon carbide, or the like may be illustrated as the porous material. It can be used as these one kind or these compounds. A process for forming the clay can be carried out by a method such as, for example, an extrusion molding method, an injection-molded method, a press molding method, a method which forms a through-hole after forming into a shape of a column, or the like. In case of adopting the extrusion molding method, it can be realized by using a vacuum auger machine, a ram type extruder, or the like. Drying means is not limited, but it is preferable to dry by a method combined microwave drying and hot-air drying or a method combined dielectric drying and hot-air drying.

Alternatively, predetermined cells 53 in both end surfaces of the resulted formed honeycomb body 51 are plugged by a plugging material to form the plugged portions 56a, 56b. After the plugging material constituted the plugged portions 56a, 56b is dried, the whole dried honeycomb body is fired to obtain the plugged honeycomb structure 81 (see FIG. 8).

The plugging material to plug the cells 53 is preferable to use slurry based on a ceramic material as a major component which is prepared so that the firing shrinkage rate becomes predetermined rate relative to that of the formed honeycomb body 51. A material constituted this plugging material is not always necessary to be the same as a forming material of the formed honeycomb body 51, but is desirable to be the same material as the forming material so as to make the firing shrinkage rate conform. The slurry is obtained by kneading the ceramic material with water, a binder, a dispersant, and the like with the viscosity of almost 200 dPa·s.

Plugging the predetermined cells 53 of the formed honeycomb body 51 can be performed as below; conducting a mask only cells 53 which are not plugged in the plurality of cells 53 with pasting a film, applying a slurry to a base of a plate shaped container which the base is flat based on the method for applying the slurry used the above-mentioned slurry (a plugging material) of the present invention, inspecting application defects of the slurry applied by means of the method for inspecting defects of the slurry application of the present invention, and immersing the end surface of the formed honeycomb body 51 which is masked only at unplugged cells 53 in the slurry after confirming the absence of the applying defects of the slurry applied to the container (see FIG. 7). In addition, FIG. 7 is a sectional view which shows a state that the end surface of the formed honeycomb body 51 is immersed in the slurry 31 applied to the container 2.

The masking by pasting up the film is carried out as below. The film made of polyester, for example, is applied. Alternatively, an adhesive agent is applied to the one surface of the film and the film is pasted to the end surface of the formed honeycomb body 51. Then, portions corresponding to unplugged cells 53 of the formed honeycomb body 51 pasted the film is perforated by a laser device, for example. FIG. 6 is a plane view to show the end surface of the formed honeycomb body 51 which gave the masking. In an example as shown in FIG. 6, masking portions 55 by pasting up the film is disposed in a checkered pattern.

The slurry applying to the base of the container is carried out by the following; the slurry applying device 1 shown in FIGS. 1 and 2 is used and the position of the discharge opening of the pump 3 is relatively moved from center 22 to periphery 23 of the base 21 of the container 2 by the discharge opening moving means, and the slurry 31 is discharged to the base 21 of the container 2 while rotating the container 2 as a rotating axis with the center 22 of the base 21 by the container rotating means for application. In this time, it is preferable that the thickness of the slurry 31 discharged in a plurality of positions on the base 21 of the container 2 are measured by means of the displacement meter 5 which is moved by the displacement meter moving means, more than any one of the discharge volume of the slurry 31 of the pump 3, the rotating rate of the container 2 and the moving rate of the discharge opening of the pump 3 are regulated and the slurry 31 is applied to the base 21 of the container 2 based on the thickness of the slurry 31 in each position measured. Preferably, the thickness of the slurry 31 is around 0.5-5 mm.

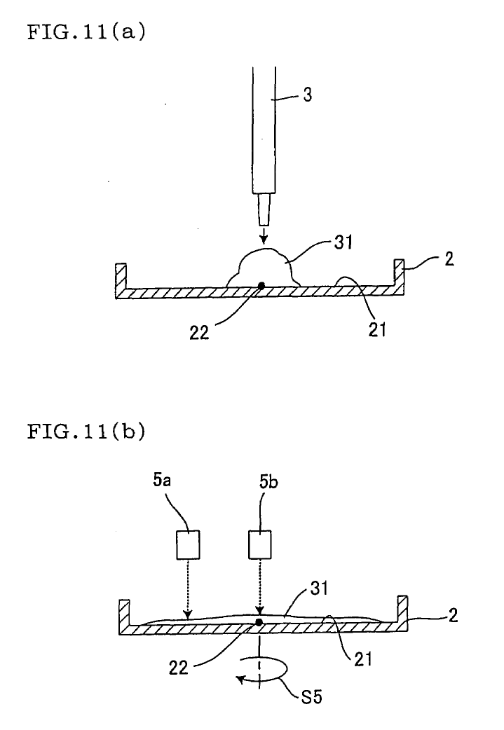

In addition, the slurry applying device 1 comprises the displacement meter moving means and the discharge opening moving means, but the slurry applying device of the present invention does not include these as essential constituent elements. The slurry can be applied so as to make it a uniform thickness by also a slurry applying device without these (or even without using the displacement meter moving means and the discharge opening moving means in the slurry applying device 1). FIG. 11 is a sectional view the slurry applying device which shows a state of the slurry application by means of the slurry applying device which does not comprise the displacement meter moving means and the discharge opening moving means (or in case of without using the displacement meter moving means and the discharge opening moving means). FIG. 11 (a) shows a state just after that the slurry was discharged, and FIG. 11 (b) shows a state that the slurry becomes flat. At first, in this case, the slurry 31 is discharged as target position with center 22 of the base 21 of the container 2 from the discharge opening of the pump 3 (see FIG. 11 (a)). Next, the container 2 is rotated as a rotating axis with center 22 of the base 21 of the container 2 (as arrow S5 shown in FIG. 11 (b)), and the slurry 31 is spread in layer by a centrifugal force (see FIG. 11 (b)). In this time, for example, by means of two displacement meters 5a, 5b, the thicknesses of the slurry 31 in two different positions of the slurry 31 are measured. Alternatively, if needed, more than any one of the discharge volume of the slurry 31 of the pump 3 and the rotating rate of the container 2 is regulated based on the thickness of the slurry 31 measured in two different positions, and the slurry 31 is applied to the base 21 of the container 2.

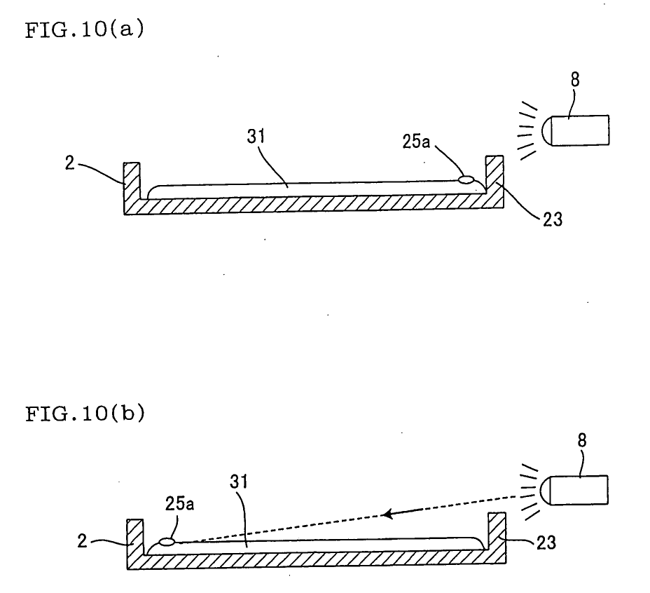

Inspection of defects of the slurry application is carried out by using the device for inspecting defects of the slurry application 10 shown in FIGS. 3 and 4, lighting from above and lateral of the base 21 of the container 2 to the slurry 31 applied to the base 21 of the container 2, and identifying the presence or absence of non-applying parts 24 or the air bubble 25 by means of images taken from above of the base 21 of the container 2 by the camera 6. According to the upward lighting 7, a color difference of each material between the slurry 31 and the container 2 can be easily detected by image processing, so that non-applying parts 24 (see FIG. 4) of the slurry 31 can be entirely detected. On the other hand, the air bubble 25 cannot be always detected with the upward lighting 7, because it is hard to produce a shadow with the upward lighting 7. However, according to the lateral lighting 8, a shadow of the air bubble 25 in the slurry 31 can be easily detected by the image processing. It is noted that though the lateral lighting 8 is a means to light to express a shadow of the air bubble from a lateral of the slurry 31, thereby the air bubble which are near to the lateral lighting 8 are not lighted up with the lateral lighting 8 because periphery 23 of the container 2 becomes obstacle, so that it may be a detective leakage. FIG. 10 (a), (b) are figures showing a state, and they are sectional views of the device for defects of the slurry application. FIG. 10 (a) shows a state that the air bubble 25a which is near to the lateral lighting 8 is not lighted up with the lateral lighting 8 by obstacle of periphery 23 of the container 2. In order to solve such a problem, the container 2 may be rotated in inspecting by means of the container rotating means for inspection. When the container 2 is rotated, the air bubble that are existed near the lateral lighting 8 are lighted up with the lateral lighting 8 which move far from the lateral lighting 8. FIG. 10 (b) shows a state that the air bubble 25a which move far from the lateral lighting 8 are lighted up with the lateral lighting 8. In addition, as a specific inspecting means of the air bubble by the lateral lighting 8, an inspection method is provided, for example, by fixing the lateral lighting 8 at place shown in FIG. 3, (it is not moved), mainly lighting ¼ of the full area of the base 21 of the container 2 to inspect, rotating ¼ of the container 2 and stop after the inspection, and repeating this process, and then stopping after the container are rotated at one round. While the air bubble go round, the air bubble is lighted up with the lateral lighting 8 at an either place to produce a shadow, so that the inspection will not leaked out.

A drying after the plugging can be conducted by drying for about 5 minutes, for example, with an exposure of 120° C. of a hot air used, for example, a hot-air blower, a hot plate, a far infrared rays dryer, or the like, on the end surface of the side where is filled with the slurry after the plugging the formed honeycomb body 51.

A firing of the formed honeycomb body 51 which gave the plugging can be performed by selecting the rate of temperature rise and the rate of cooling, adequately, used, for example, a single kiln or a continuous furnace such as tunnels, or the like. As the above-mentioned, plugged honeycomb structures 81 as shown in FIGS. 8 and 9 can be produced.

### EXAMPLES

The results carried out a method for manufacturing a plugged honeycomb structure of the present invention will hereinbelow be described specifically with referring to Examples.

A formed honeycomb body was obtained by mixing a binder and water with a cordierite forming material which main materials were the above-mentioned talc, kaolin, alumina as raw materials, for example, extruding the forming materials, which were dispersed, mixed and kneaded, into the shape of a column by a kneading machine, and then extruding it by a extrusion molding machine. In case of manufacturing a honeycomb structure by using the above obtained formed honeycomb body, a dried honeycomb body was obtained firstly by cutting the obtained formed honeycomb body to predetermined length after drying, and then fired honeycomb body was obtained by firing after plugging alternately a group of cells of both end surfaces of the dried honeycomb body. Secondly, after removing a peripheral wall and partition walls for about 1-3 cells from the outermost circumference of this obtained fired honeycomb body by grinding, a cordierite honeycomb structure could be obtained by means of forming a peripheral wall by applying a ceramic coating material to periphery thereof. By means of such a method, a honeycomb structure which cross-sectional shape of cells was a quadrangle, the thickness of partition walls was 0.3 mm, reference cell density was 300 cpsi (46.5 cells/cm²), an external shape of a honeycomb structure body after the peripheral coating was a cylindrical (outer diameter: 191 mm, length: 203 mm), a depth of plugging was 10 mm, for example, were able to be manufactured.

In a conventional plugging method, accuracy of the depth of plugging was 10±5 mm, however, by means of the present method, accuracy of 10±2 mm was obtained. A slurry is elongated to an outside direction of a container by rotating a container, however, in a conventional method, the thickness of the slurry in a central part of the container was thicker than in a peripheral part if the rotation was completed before a slurry have not be elongated enough in a conventional method, therefore, a depth of plugging was also deepened in the central part of an end surface of a honeycomb structure. On the other hand, if the rotation of a container was excessive, the thickness of the slurry was thinner in the central part of the container than in a peripheral part, so that a depth of plugging was shallow in the central part of the end surface of a honeycomb structure.

Similarly, a honeycomb structure which cross sectional shape of cells was a quadrangle, the thickness of partition walls was 0.3 mm, reference cell density was 200 cpsi (31 cells/cm²), and an external shape of a honeycomb structure body after the peripheral coating was a cylindrical (outer diameter: 229 mm, length: 305 mm), and a honeycomb structure which a plugging depth accuracy was the same as the above-mentioned value and an external shape of a honeycomb structure body after the peripheral coating was a cylindrical (outer diameter: 460 mm, length: 500 mm) were able to be obtained. As a characteristic of these honeycomb structures, porosity was 45 to 70%, the diameter of average pore diameter was 5 to 30 μm, average coefficient of thermal expansion of an axial direction was about 0.1 to 1.0×10⁻⁶/° C. at 40-800° C.

In addition, using the same material, a honeycomb structure having an outside diameter from 191 mm to 460 mm were also manufactured, in which a cross-sectional shape of cells was a combination of an octagon and a quadrangle, the thickness of partition walls was 0.41 mm, and reference cell density was 300 cpi (46.5 cells/cm²). Further, a honeycomb structure which a configuration thereof obtained by an integral forming that was not circumferentially processed was cylindrical (outer diameter: 144 mm, length: 152 mm) and a depth of plugging was 3 mm, was able to be manufactured. In a conventional plugging method, an accuracy of a depth of plugging was 3±2 mm, however, an accuracy of 3±1 mm was obtained by the present method. By this method, a depth of plugging was possible to be made shallower to 1 to 2 mm.

### INDUSTRIAL APPLICABILITY

It is preferable that a slurry applying device and a device for inspecting defects of a slurry application of the present invention can be employed to a means for manufacturing a plugged honeycomb structure used as a filter, a catalyst or the like which purifies exhaust gas emitted from diesel engines, or the like.

What is claimed is:

1. A slurry applying device comprising a plate shaped container which a base is flat, a slurry discharge means to discharge a slurry to the base of the container, a container rotating means for application to rotate the container, and the displacement meter which measures the thickness of slurry discharged by the slurry discharge means.

2. A slurry applying device according to claim 1, further comprising a displacement meter moving means to move the displacement meter.

3. A slurry applying device according to claim 1, further comprising a control means A, regulating more than any one of the discharge volume of a slurry of the slurry discharge means and the rotating rate of the container rotating means for application based on data of the thickness of the slurry measured by the displacement meter, together with inputting the thickness.

4. A slurry applying device according to claim 1, further comprising a discharge opening moving means which relatively moves a position of a discharge opening of the slurry discharge means between center and periphery of the base of the container.

5. A slurry applying device according to claim 4, further comprising a control means B, regulating moving rate of the discharge opening moving means based on data of the thickness of the slurry, together with inputting the thickness of the slurry measured by the displacement meter.

6. A slurry applying device according to claim 1, the displacement meter is a laser displacement meter.

7. A method for applying a slurry to a base of the plate shaped container which the base is flat, in which the method comprises measuring the thickness of the slurry discharged together with discharging the slurry to the base of the container while rotating the container by using a slurry discharge means, and regulating more than any one of the discharging volume of the slurry and the rotating rate of the container based on the thickness of the slurry measured.

8. A method for applying a slurry according to claim 7, regulating the moving rate of a discharge opening based on the thickness of the slurry measured together with relatively moving a position of the discharge opening of the slurry discharge means between center and periphery of the base of the container.

9. A method for manufacturing a plugged honeycomb structure comprising a process which includes manufacturing a formed honeycomb body having a plurality of cells which penetrate in axial direction divided by porous partition walls, conducting a mask only cells which are not plugged in the plurality of cells being opened in an end surface of the formed honeycomb structure with pasting a film, applying a slurry to a base of a plate shaped container which the base is flat by measuring the thickness of the slurry discharged together with discharging the slurry to the base of the container while rotating the container by using a slurry discharge means and regulating more than any one of the discharging volume of the slurry and the rotating rate of the container based on the thickness of the slurry measured using the slurry consisting of a ceramic material, and firing the formed honeycomb body after an end surface of the formed honeycomb body masked only the cells without plugging is immersed in a slurry applied to the container to plug by a slurry consisting of a ceramic material.

10. A device for inspecting defects of a slurry application comprising a plate shaped container which a base is flat and a slurry is applied to the base, a camera which images the slurry applied to the base, located above the base of the container, and an upward lighting which lights the slurry applied to the base from upward, located similarly above the base of the container.

11. A device for inspecting defects of a slurry application comprising a plate shaped container which a base is flat and a slurry is applied to the base, and a laser line sensor which images the slurry applied to the base, located above the base of the container.

12. A device for inspecting defects of a slurry application according to claim 10, further comprising a camera position moving means which relatively moves a position of the camera between center and periphery of the base of the container.

13. A device for inspecting defects of a slurry application according to claim 10, further comprising an upward lighting position moving means which relatively moves a position of the upward lighting between center and periphery of the base of the container.

14. A device for inspecting defects of a slurry application according to claim 10, further comprising a lateral lighting which lights slurry applied to the base from lateral, located in a lateral of a base of the container.

15. A device for inspecting defects of a slurry application according to claim 11, further comprising a lateral lighting which lights slurry applied to the base from lateral, located in a lateral of a base of the container.

16. A device for inspecting defects of a slurry application according to claim 14, further comprising a lateral lighting position moving means which relatively moves a position of the lateral lighting along periphery of the container.

17. A device for inspecting defects of a slurry application according to claim 15, further comprising a lateral lighting position moving means which relatively moves a position of the lateral lighting along periphery of the container.

18. A device for inspecting defects of a slurry application according to claim 10, further comprising a container rotating means for inspection to rotate the container as a rotating axis with center of the base.

19. A device for inspecting defects of a slurry application according to claim 11, further comprising a container rotating means for inspection to rotate the container as a rotating axis with center of the base.

20. A method for inspecting defects of slurry applied to a base of a plate shaped container which the base is flat, in which the method is a method for inspecting defects of a slurry application and comprises lighting slurry applied to the base of the container from upward and lateral of the base of the container, and inspecting defects of application by means of taken images by a camera from upward of the base of the container.

21. A method for manufacturing a plugged honeycomb structure comprising a process which includes manufacturing a formed honeycomb body having a plurality of cells which penetrate in axial direction divided by porous partition walls, conducting a mask only cells which are not plugged in the plurality of cells and are opened in an end surface of the formed honeycomb structure with pasting a film, applying a slurry to a base of a plate shaped container which the base is flat by using the slurry consisting of a ceramic material, inspecting defects of application of the slurry applied to the base of the container by lighting slurry applied to the base of the container from upward and lateral of the base of the container and inspecting defects of application by means of taken images by a camera from upward of the base of the container, and firing the formed honeycomb body after an end surface of the formed honeycomb body masked only the cells which are not plugged is immersed in the slurry applied to the container to plug by a slurry consisting of a ceramic material when the defects are not detected in the slurry applied to the container.
